(19) United States
(12) Patent Application Publication
(10) Pub. No.: US 2021/0142778 A1
(43) Pub. Date: May 13, 2021

(54) Porous Acoustic Phase Mask

(71) Applicants: Universite de Bordeaux, Bordeaux (FR); Centre National de la Recherche Scientifique (CNRS), Paris (FR); Institut Polytechnique de Bordeaux, Talence (FR); Ecole National Superieure D'Arts Et Metiers (ENSAM), Paris (FR)

(72) Inventors: Olivier Mondain-Monval, Talence (FR); Thomas Brunet, Bordeaux (FR); Olivier Poncelet, Merignac (FR); Yabin Jin, Bordeaux (FR); Raj Kumar, Bordeaux (FR); Samuel Marre, Pessac (FR); Artem Kovalenko, Cachan (FR)

(73) Assignees: Universite de Bordeaux, Bordeaux (FR); Centre National de la Recherche Scientifique (CNRS), Paris (FR); Institut Polytechnique de Bordeaux, Talence (FR); Ecole Nationale Superieure D'Arts Et Metiers (ENSAM), Paris (FR)

(21) Appl. No.: 17/040,662

(22) PCT Filed: Mar. 25, 2019
(86) PCT No.: PCT/EP2019/057427

§ 371 Date: Sep. 23, 2020

(30) Foreign Application Priority Data
Mar. 23, 2018 (FR) 1852569

(51) Int. Cl. G10K 11/30; C08J 9/00; C08J 9/40

(52) U.S. Cl. CPC G10K 11/30; C08J 9/0023; C08J 9/40; C08J 2205/048; C08J 2205/026; C08J 2333/08; C08J 2203/08; C08J 2201/036; C08J 2201/032; C08J 2383/04; C08J 2203/202

(57) ABSTRACT

The invention relates to an acoustic phase mask, the phase mask having a variation in the acoustic index n, characterized in that the phase mask comprises a body comprising:
at least one matrix formed from a deformable solid material, having a shear modulus of less than 10 MPa, and
pores formed in the matrix, the pores being mostly filled with gas, the deformable solid material extending between the pores, the body having a porosity φ less than or equal to 50%, and a controlled porosity φ gradient resulting in a variation of the acoustic index n spatially in the body.

### FIELD OF THE INVENTION

The invention relates to an acoustic phase mask for the spatial manipulation of acoustic wavefronts, for example an acoustic lens for focusing an acoustic wave.

### PRIOR ART

The spatial manipulation of acoustic wavefronts, and particularly the focusing of acoustic waves, is typically carried out using metamaterial devices, notably in a frequency range corresponding to audible and/or ultrasonic frequencies.

Zhu et al. (Zhu, H., & Semperlotti, F. (2015), Improving the performance of structure-embedded acoustic lenses via gradient-index local inhomogeneities, International Journal of Smart and Nano Materials, 6(1), 1-13.) describes for example a device for focusing an ultrasonic wave propagating in an aluminum plate. Inhomogeneities or inclusions are formed by openings in the aluminum plate so as to form a waveguide, making it possible to focus an initially radial ultrasonic wave. This method is difficult to transpose industrially to the manipulation of acoustic waves in three dimensions, and in other acoustic wave propagation media in which it is not possible to create openings.

Martin et al. (Martin, T. P., Naify, C. J., Skerritt, E. A., Layman, C. N., Nicholas, M., Calvo, D. C., . . . . & Sánchez-Dehesa, J. (2015), Transparent gradient-index lens for underwater sound based on phase advance, Physical Review Applied, 4(3), 034003.) describes a device comprising an anisotropic array of hollow aluminum cylinders arranged to form an acoustic index gradient n in the device. An incident sound acoustic wave, passing through the array of cylinders, is focused in predefined regions of space. The manufacture of such a device requires precise and expensive mechanical assembly, limiting its industrial application.

### SUMMARY OF THE INVENTION

One goal of the invention is to produce an acoustic phase mask that is easier to implement or to manufacture than the devices of the prior art.

These goals are achieved in the present invention by virtue of an acoustic phase mask, the mask having a variation in the acoustic index n, characterized in that the phase mask comprises a body comprising:
at least one matrix formed of a deformable solid material having a shear modulus of less than 10 MPa, and
pores formed in the matrix, the pores being mostly filled with gas, the deformable solid material extending between the pores, the body having a porosity φ less than or equal to 50%, and a controlled porosity φ gradient resulting in a variation of the acoustic index n spatially in the body.

The invention can be advantageously complemented by the following features, taken individually or in any one of their technically possible combinations:
the phase mask is an acoustic lens, the porosity gradient being such that the lens is able to focus an incident plane acoustic wave transmitted by the phase mask to at least one point in space,
the phase mask has two opposite flat sides extending parallel to a main plane and having at least one porosity φ gradient oriented a direction parallel to the main plane,
the porosity is distributed in the body in such a way as to correspond to an index n changing linearly according to the direction, in at least a part of the phase mask,
the porosity is distributed in the body in such a way as to correspond to an index n changing hyperbolically according to the direction, in at least a part of the phase mask,
the phase mask comprises a juxtaposition of layers comprising a matrix and pores, each layer having a constant porosity φ, the porosity of one layer being different from the porosity of a directly adjacent layer,
the phase mask comprises a support having cells, each cell containing a matrix, at least two matrices having different porosities,
the two opposite flat sides are separated by a thickness d, the thickness d being between 100 μm and 10 mm. Indeed, this range of thickness d is suitable for the manipulation of acoustic waves having a wavelength comprised between 100 kHz and 10 MHz.

Another aspect of the invention relates to a process for manipulating acoustic wavefronts, comprising a step of installing an acoustic phase mask described above in the propagation space of an incident plane acoustic wave having a wavelength λ.

The phase mask can advantageously have a thickness d in one direction of propagation of the incident acoustic wave, the thickness d being strictly less than the wavelength λ.

Another aspect of the invention relates to a process for manufacturing a phase mask described above, the method comprising steps of:
forming a plurality of emulsions, each emulsion having on the one hand a first liquid phase, and on the other hand a second phase comprising monomers and at least one type of surfactant, so as to form drops of the first liquid phase in the second phase, at least two emulsions having different respective first phase fractions,
cross-linking the monomers of the emulsions so as to forma deformable solid material defining the matrix or matrices and pores comprising the first liquid phase,
drying to remove the first liquid phase so that the pores are mostly filled with gas.

The invention can be advantageously complemented by the following features, taken individually or in any one of their technically possible combinations:
the drying step is a step of supercritical drying of the first liquid phase,
the first liquid phase comprises, during the supercritical drying step, successively water, a liquid selected from ethanol and acetone, and carbon dioxide,
the first liquid phase comprises a liquid compound adapted to spontaneously decompose at room temperature into a gas and a liquid, and in which, during the drying step, the liquid compound is allowed to decompose so as to form a gas phase in the pores,
the compound is hydrogen peroxide,
the cross-linking of the monomers is carried out by exposing the emulsions to ultraviolet radiation.

### DESCRIPTION OF THE DRAWINGS

Other features and advantages will become further apparent in the following description, which is purely illustrative and non-limiting, and should be read in relation to the appended figures, among which:

FIG. 1 illustrates a phase mask according to an embodiment of the invention,

FIGS. 2a, 2b and 2c illustrate a process for manufacturing a porous material,

FIG. 3 illustrates a supercritical drying step,

FIGS. 4a, 4b and 4c are microphotographs of porous materials,

FIG. 5 is a diagram illustrating the change in the porosity of a porous material as a function of the volume fraction in the first dispersed phase after drying for different drying methods,

FIG. 6 illustrates the manipulation of an incident plane wave by a phase mask according to an embodiment of the invention,

FIG. 7 illustrates the change in the longitudinal velocity of an acoustic wave in a porous elastomeric material according to an embodiment of the invention as a function of the porosity of the porous elastomeric material,

FIGS. 8a, 8b, 8c, 8d, 8e and 8f illustrate a process for manufacturing a phase mask according to an embodiment of the invention,

FIGS. 9a, 9b, 9c and 9d illustrate a process for manufacturing a phase mask according to an embodiment of the invention,

FIGS. 10a and 10b illustrate the deflection of an incident plane wave at a predetermined angle, as well as the phase mask adapted for this deflection,

FIGS. 11a and 11b illustrate the focusing of an incident plane wave toward a predetermined focal point, as well as the phase mask adapted for this focusing,

FIGS. 12a, 12b and 12c illustrate experimental measurements allowing the deflection and focusing of acoustic waves carried out by phase masks according to the embodiments of the invention.

### DEFINITIONS

The “porosity” of a porous material is defined the ratio of the pore volume of the porous material to the total volume of the porous material (i.e. the sum of the pore volume of the porous material and the volume of solid material extending between the pores).

“Manipulation” of an acoustic wave (or of the acoustic wavefront) means any deliberate and controlled modification of said front (local phase, amplitude and/or polarization), for example the deflection or focusing of an acoustic wave.

A “phase mask” is defined as any device that allows the phase of an incident wave passing through it to be modified locally. Preferably, the phase mask is a planar device.

An “emulsion” is defined as a mixture of two immiscible liquid substances, one being homogeneously dispersed in the form of drops in the other.

### DETAILED DESCRIPTION OF AN EMBODIMENT OF THE INVENTION

### General Architecture of an Acoustic Phase Mask

FIG. 1 shows a section of an acoustic phase mask 1. The phase mask 1 includes a body 2. The body 2 allows a simplified use of the phase mask 1, compared with other known devices, such as obstacle arrays or transducer arrays.

The body 2 comprises at least one matrix 3, formed in a deformable solid material, and pores 4 formed in the matrix 3. The majority of the pores 4 are filled with gas, allowing the body 2 to be compressible (compressibility is comprised between 10⁹ Pa⁻¹ for the non-porous body 2 to 10⁻⁶ Pa¹ for the body 2 having 40% gas-filled pores). The deformable solid material extends between the pores 4. This material has a shear modulus preferentially less than 10 MPa.

The pores 4 give the body 2 a local porosity φ. The body 2 has a porosity of less than 50%, i.e. the local porosity at any point in the body 2 is less than 50%. In other words, the maximum porosity of the body 2 is less than 50%.

The body 2 has a porosity φ gradient. This porosity gradient in the body 2 is controlled and leads to a spatial variation of the acoustic index n in the body 2. The variation of the acoustic index n, or the acoustic index n gradient, leads to a modulation of the incident wavefront during its passage through the phase mask 1, allowing for example to focus an incident wave, particularly an incident plane wave.

FIG. 1 illustrates a phase mask 1 in section: the phase mask 1 has two opposite flat sides extending parallel to a main plane 7 and the body 2 of the phase mask 1 has a porosity gradient oriented in a direction parallel to the main plane 7. With reference to FIG. 1, the main plane 7 is parallel to the plane defined by the x and y axes, and the gradient is oriented along the x axis. More precisely, the body 2 has a decreasing porosity φ along the x axis.

### Manufacture of a Porous Material

The body 2 is at least partly made of porous material, i.e. a material comprising the matrix 3 of deformable solid material, and the pores 4, the deformable solid material of the matrix 3 extending between the pores 4. The porous material is manufactured by polymerization of an aqueous emulsion in a polymerizable solvent, for example thermally or by UV irradiation and subsequent drying.

The solid deformable material includes elastomeric polymers. These polymers have glass transition temperatures below room temperature. In particular, the polymers of the deformable solid material have a glass transition temperature below −50° C., preferably below −80° C., and preferably below −100° C.

Due to the high porosity of the porous material, the filling of the pores 4 mostly with gas, and the deformability of the solid material, the body 2 may have a higher compressibility than known porous materials.

The acoustic index n of a material can be defined by the formula (1):

n=c_{ref}/cₘₐₜ (1)

where c_{ref} and cₘₐₜ are respectively the propagation velocities (or celerities) of the longitudinal acoustic waves in a reference material, i.e. water in the invention, for which c_{ref}=1500 m·s⁻¹, and in the material under consideration. As the propagation velocity of an acoustic wave in a material depends on the porosity of the material, the acoustic index n depends on the porosity. A porosity gradient of the porous material thus leads to an acoustic index gradient n in the body 2 of the phase mask 1.

The porous material can have a wide range of propagation velocities. Indeed, the propagation speed of sound in a material can be written as follows cₘₐₜ=(M/ρ)^{1/2} where ρ is the density of the material and M is the compressive elastic modulus of the material. The velocity of an acoustic wave in the porous material decreases when both the compressive elastic modulus of the porous material decreases and the density of the porous material increases.

Thus, the porosity of the porous material can be adjusted to exhibit propagation velocities between typically 10 m·s¹ and 1000 m·s¹. Known devices do not allow variations in propagation velocities with such a high amplitude.

With reference to FIGS. 2a, 2b and 2c, the manufacture of a phase mask 1, and in particular the porous material of one or more matrices 3 of the phase mask 1 comprises the steps of:

a) forming a plurality of emulsions 12, each emulsion 12 having, on the one hand, a first liquid phase 13 and, on the other hand, a second phase 14 comprising monomers and at least one type of surfactant, so as to form drops of the first liquid phase 13 in the second phase 14.

At least two emulsions 12 have different fractions in the first phase 13. The step of forming an emulsion is illustrated in FIG. 2a.

b) cross-linking the monomers of the emulsions 12 so as to form a deformable solid material 3 defining the matrix or matrices 3 and the pores 4 containing the first liquid phase 13.

The cross-linking step is illustrated in FIG. 2b.

c) drying the porous material obtained in step b) to remove the first liquid phase 13 so as to mostly fill the pores 4 with gas.

The drying step is illustrated by FIG. 2c.

During step a), each inverse emulsion 12 is made between, on the one hand, a second phase 14 comprising monomers and a suitable surfactant, and on the other hand a first aqueous phase 13. The emulsion 12 can be made using a shearing device (for example Rayneri, Ultraturrax, or any mechanical device allowing sufficient shearing of the two phases). The emulsion can also be formed by exposing the first phase 13 and the second phase 14 to ultrasonic waves. The “stock emulsion” is defined as the emulsion 12 thus obtained. The volume fraction of the stock emulsion 12 in the first phase 13 can be between 0% and 90%. The choice of surfactant is adapted to the monomers chosen in the second phase 14. Generally, the surfactant has an HLB number less than or equal to about 8. Thus, an inverse emulsion 12, i.e. comprising drops of aqueous first phase 13 in a lipidic second phase 14, is favored. The diameter of the first phase 13 drops formed in the second phase 14 is typically comprised between 0.1 and 100 μm.

During step b), the emulsions 12 are deposited in one or more containers. At least two emulsions 12 have different fractions in the first phase 13. The first phase 13 fraction may also vary in a controlled manner during the deposition of one emulsion 12 in a container, forming a plurality of emulsions 12 continuously. The container can be, for example, a mold or a honeycomb. A container wall can be formed by an already cross-linked emulsion 12. Once deposited, the monomers of the second phase 14 of the emulsion 12 are cross-linked to form a deformable solid material. The cross-linking of the monomers can preferentially be carried out by exposing the monomers to ultraviolet radiation or to heating. At the end of step b), one or more matrices 3 of deformable solid material are obtained. Pores 4 are formed by the matrix or matrices 3, which are filled with the first phase 13.

During step c), the matrix or matrices 3 is/are dried. This step makes it possible to replace, at least in majority and preferentially completely, the first liquid phase 13 contained in the pores 14 by the gas. Typically, the drying of the first phase 13 is carried out by pervaporation of the first liquid phase 13 through the polymer matrix 3.

In known drying methods, a drying front propagates in the matrix 3, and more particularly at the interface between the matrix 3 and the pores 4. The matrix 3 is then subjected to a drying pressure P_{drying} equal to twice the surface tension □ of the first phase liquid 13 with air, divided by the radius r of the micropores through which the first phase 13 escapes during pervaporation, i.e. P_{drying}=2γ/r. Although it is difficult to know the exact value of r, it can be estimated that r is typically less than or equal to 1 nm. Thus, for a first phase 13 of water (□=72 mN/m), P_{drying}≈144 MPa. This value, indicative, is higher than the typical shear modulus of the deformable solid material, in elastomeric polymers. Consequently, pore collapse is observed when using known drying methods, and the porosity of a porous material is thus limited because no gas replaces the disappearance of first phase 13 in the pores 4.

According to one aspect of the invention, the drying step is a step of supercritical drying of the porous material to remove the first liquid phase 13. The supercritical drying method is known for drying brittle porous materials such as aerogels. It is for example described by Marre et al. (Mane, S., & Aymonier, C. (2016), Preparation of Nanomaterials in Flow at Supercritical Conditions from Coordination Complexes. In Organometallic Flow Chemistry (pp. 177-211). Springer, Cham.). During supercritical drying, a liquid phase contained in the pores 4 is transformed into a gaseous phase, without phase transition, by imposing temperature and pressure conditions that allow to bypass the critical point of the compound(s) contained in the pores 4. The absence of passage through a phase transition line avoids a drying front between a liquid and a gaseous phase. Thus, the drying pressure is decreased or equal to zero, and it is possible to avoid the crushing of the porous material on itself during drying.

The drying fluid used for supercritical drying can be CO₂. CO₂ has a critical point corresponding to a pressure P_{C}=73.9 atm and a temperature T_{C}=31° C. These temperature and pressure conditions are easy and economical to implement.

FIG. 3 shows the supercritical drying of the porous material using CO₂. Following step b), the pores 4 contain a first aqueous phase 13. The first phase 13 is first exchanged with liquid ethanol. Thus, the liquid contained in the pores 4 is miscible with CO₂. The exchange of the first phase 13 with a liquid ethanol phase is achieved by immersing the porous material in a bath of aqueous solution which is gradually enriched with ethanol by a pump system at ambient temperature and pressure. The exchange takes place progressively, on a time scale adapted to avoid imposing too high mechanical stresses on the deformable solid material.

The ethanol is then extracted by CO₂. Extraction is carried out by placing the porous material soaked in pure ethanol in a high-pressure reactor, in which the pressure and temperature conditions can be adjusted by means of injection pumps and an outlet pressure regulator. The reactor temperature is first adjusted above the theoretical critical temperature of the CO₂/ethanol mixture (i.e. between 45 and 50° C. for a 90/10 molar composition) while the reactor is slowly pressurized with CO₂, up to a value above the critical pressure of the CO₂/ethanol mixture (i.e. 110 bar). These variations in pressure and temperature correspond to the trajectory illustrated by dotted lines from point A to point B in FIG. 3.

The CO₂ is then continuously pumped through the porous material at a constant flow rate (11 g/min), while the operating conditions are kept constant (the pressure is controlled by an outlet pressure controller). The CO₂ mixes with ethanol and forms a single-phase supercritical mixture. During this mixing phase, the ethanol contained in the pores 4 is gradually replaced by a supercritical CO₂/ethanol mixture which is gradually enriched with CO₂. At the same time, the fluid ethanol/CO₂ mixture is extracted from the reactor in order to maintain a constant internal fluid volume. Once all the ethanol has been replaced by CO₂, the pressure in the system is slowly reduced to 1 bar, for example in one hour, so as to return the CO₂ to the gaseous phase without returning to the liquid state. This pressure change corresponds to the dashed line from point B to point I in FIG. 3.

Finally, the temperature is lowered to room temperature. This temperature variation corresponds to the trajectory illustrated by dotted lines from point I to point A in FIG. 3. Thus, the fluid contained in the pores 4 is continuously replaced by a gas, avoiding the appearance of a triple solid/liquid/gas interface (of non-zero surface tension) in the pores 4.

According to another aspect of the invention, the first liquid phase 3 comprises a liquid compound adapted to spontaneously decompose at room temperature into a gas and a liquid. The kinetics of decomposition of the liquid into a gas and a liquid product can be determined by the proportion of liquid that can decompose in the dispersed phase. This kinetics can be adjusted so that the characteristic time for the appearance of gas bubbles is typically slower (i.e. typically more than 30 minutes) than the time required for emulsification. During the drying step, the liquid compound is allowed to decompose to form a gas phase in the pores 4. The compound 1 can be hydrogen peroxide H₂O₂. Hydrogen peroxide decomposes at constant ambient temperature and pressure into water (liquid) and gaseous oxygen. The proportion of H₂O₂ in the first liquid phase 13 may be preferentially ⅓ by total mass of the first phase 13. For a proportion of H₂O₂ in water of ⅓, the characteristic time of appearance of the gas bubbles is about 30 minutes. This kinetics can be slowed or accelerated by adjusting this proportion or by adding a catalyst in controlled concentration in the dispersed phase (for example iodide ions I which are known to catalyze the decomposition reaction of H₂O₂ into oxygen and water). This method makes it possible to compensate for the pressure potentially exerted, during drying, by contact lines in the pores 4 by an increase in gas pressure caused by the decomposition of the compound. It is thus possible to avoid the collapse of the pores 4 on themselves during the drying of the porous material. This method does not require external control of the pressure and/or temperature imposed on the porous material. Thus, the use of the compound makes it possible to dry the porous material using a simpler and less expensive material than in supercritical drying. Drying by introduction of the compound is for example achieved by placing the porous material in an oven, in which the temperature is controlled at 40° C., under ambient atmosphere.

The two drying processes described above (supercritical drying and introduction of a compound in the first liquid phase 13) make it possible to obtain a porosity of the porous material substantially equal to the volume fraction in the first phase 13 obtained during step a) of the process.

FIGS. 4a, 4b and 4c are microphotographs obtained by scanning electron microscopy, illustrating porous materials of the body 2 with different porosities. With reference to FIG. 4a, the porosity φ of the porous material of the body 2 is substantially equal to 5%. With reference to FIG. 4b, the porosity φ of the porous material of the body 2 is substantially equal to 10%. With reference to FIG. 4b, the porosity φ of the porous body 2 is substantially equal to 15%.

FIG. 5 illustrates the change in the porosity of a porous material after a drying step carried out according to a known method (illustrated by curve (a)), a supercritical drying step (illustrated by curve (b)) and a drying step by introducing a compound in the first phase 13 (illustrated by curve (c)). The drying methods illustrated by curves (b) and (c) make it possible to obtain a porous material with a porosity φ substantially equal to the volume fraction of the first phase 13 in the emulsion 12. On the other hand, when drying by a known method (for example simple drying in an oven) is used, the collapse of the matrix 3 on itself prevents an increase in porosity above a threshold value (substantially 10%) and thus limits a possible gradient in the acoustic index n of the body 2.

### Examples of Manufacturing of the Porous Material

### EXAMPLE 1

The second phase 14 comprises Silcolease UV poly 200 silicone oil from Bluestar Silicones, 4% by mass Silcolease UV cata 211 catalyst from Bluestar Silicones, 0.4% by mass surfactant (2-octyl-1-dodecanol) and 200 ppm Genocure ITX from Rahn. The first phase 13 comprises 1.5% by mass sodium chloride. The amount of aqueous phase incorporated into the organic phase is dependent on the desired porosity of the porous material. The formation of an emulsion is achieved in a mortar by adding the first phase 13 dropwise during shearing, and then it is refined either with paddle tools (such as Rayneri or Ultraturrax) or by ultrasound. The cross-linking step is carried out by exposing the emulsion to ultraviolet radiation with the BlueWave 200 lamp from Dymax. The porous material is then dried by supercritical drying or by introducing a compound, as described above.

### EXAMPLE 2

The second phase 14 consists of 64% by mass ethylhexyl acrylate, 5.5% by mass Styrene, 10.5% by mass divinylbenzene and 20% by mass SPAN 80 surfactant. The aqueous phase has sodium chloride concentrations of 25.10⁻³ mol/L and potassium peroxodisulfate concentrations of 5.10⁻³ mol/L. The amount of first phase 13 incorporated into the organic phase is dependent on the desired porosity of the final material. The formation of an emulsion is achieved with a Rayneri type paddle tool by adding the first phase 13 dropwise during shearing. Cross-linking of the monomers is achieved by heating to a temperature of 60° C. The porous material is then dried by supercritical drying or by introducing a compound as described above.

### EXAMPLE 3

A deformable silicone-based solid material (denoted SiVi/SiH) can be obtained by thermal polymerization of PDMS via a hydrosilylation reaction. The second phase 14 comprises 8.8 g of PDMS-vinyl (BLUESIL FLD 621V1500), 1.8 g of PDMS-silane (BLUESIL FLD 626V30H2.5) and 0.352 g of platinum catalyst (SCLS CATA11091M), (BlueStar Silicones). In order to be able to prepare the emulsions 12 before the cross-linking of the monomers, 4.4 mg of polymerization retarder (1-ethynyl-1-cyclohexanol, ECH from Sigma Aldrich) is added. To stabilize the emulsion, 2-octyl-1-dodecanol or Silube J208-812 can be used. The emulsions 12 are prepared by introducing a first aqueous phase 13 comprising 1.5% by mass NaCl under stirring. The emulsion is then poured into a Teflon mold and heated at 60° C. for 24 hours. The porous material is then dried by supercritical drying or by the introduction of a compound, as described above.

### Fabrication of an Acoustic Phase Mask 1

Due to the presence of a porosity gradient leading to a spatial variation of the acoustic index n in the body 2, it is possible to locally control the velocity of acoustic waves and thus to custom bend acoustic rays by mirage effect (3D version of the gradient medium) or to control phase delays/advances at wavefronts (2D version of these media, for example a phase mask 1). Thus, it is for example possible to concentrate the acoustic beams, i.e. focus them, to deflect the acoustic beams and/or to separate the acoustic beams. “Manipulation” of the acoustic wavefront means at least one of the effects previously described on a plane incident acoustic wave.

With reference to FIG. 6 and according to an aspect of the invention, the phase mask 1 (shown in section in FIG. 6) may have a sub-wavelength thickness. The phase mask 1 has two opposite flat sides extending parallel to the main plane 7 and has at least one porosity ϕ gradient oriented in the direction 8 parallel to the main plane 7. The thickness d is defined as the distance between the two opposite flat sides. The manipulation of a plane incident acoustic wavefront 6, of length λ can be implemented with a phase mask 1 with a thickness d strictly less than the wavelength λ. Preferably, the incident wavelengths 6 are between 100 kHz and 10 MHz, in particular for water as a surrounding medium. Thus, the thickness d of the phase mask is preferably between 100 μm and 10 mm.

FIG. 6 illustrates an incident plane acoustic wave 6 with a simple physical wavefront (uniform/planar for example) at the input of the phase mask 1. The transmitted wave 19 or target wave 19 has a different wavefront than the incident plane wave 6, at the output of the phase mask 1. The output wavefront results in a volumetric “target” acoustic field (a converging field for example for focusing).

FIG. 6 also illustrates a method using a phase mask 1 to generate a sound pressure p target field (with non-planar phase fronts) from an incident plane wave 6 or an excitation plane front (for example by an ultrasonic transmitter).

Generally, so that the output pressure field is as close as possible to the target field (chosen by a user), the phase mask 1 is manufactured so that the transmission of an incident plane wave 6 by the phase mask 1 reproduces exactly at the output of the phase mask 1 the chosen target field, i.e. in z=0, and preferentially on a larger surface of the plane defined by the x and z axes.

The target pressure field can, for example, be a pulsating harmonic field w. The target pressure can be written

$${p}_{c} = {A}_{c} ( x , y , z ) {e}^{i {Φ}_{c} ( x , y , z )} {e}^{- i ω t}$$

where A is the amplitude of the pressure, Φ_{c} the target phase, and t the time. The acoustic field pₘ immediately at the output of the phase mask 1 is equal to

$${p}_{m} ( x , y ) = {A}_{m} ( x , y ) {e}^{i {Φ}_{m} ( x , y )} = {p}_{c} ( x , y , z = 0 ) .$$

The phase mask 1 makes it possible to impose the phase of the wave transmitted directly at the output of the phase mask 1, which makes it possible to establish the relation Φₘ (x, y)=Φ_{c} (x, y, z=0). It is possible to consider that the phase mask 1 has an acoustic index n variable in the plane xy and constant in its thickness d, assumed to be small with respect to λ, that is to say, to consider that n depends on x and y. The phase mask locally shifts the incident field by a quantity e^{in(x,y)k}^{₀}^{d} at each point of the output of the phase mask 1 (x,y,z=d) such that Φₘ(x,y)=Φ_{inc}(x,y,z=−1)+n(x,y)k₀d. The incident plane wave 6 can correspond to a uniform incident phase front in the plane xy, i.e. Φ_{inc} (x, y, z=−d)=Φ₀ (which can be arbitrarily set to 0). Thus, the spatial distribution of the acoustic index n of the phase mask 1 must verify the formula:

n(x,y)=Φ_{c}(x,y,z=0)/k₀d (2)

to be adapted to generate the target field p_{c}. The porosity distribution in the phase mask 1 is thus chosen so as to produce a phase mask 1 with an acoustic index n satisfying formula (2).

FIG. 7 illustrates the change in the velocity of an acoustic wave in the phase mask 1 with the porosity of the body 2. The measured celerities correspond to an acoustic index n comprised between about 1.5 and 40. The phase mask 1 is, in general, adapted to have an acoustic index comprised between 1.5 and 40.

With reference to FIGS. 8a, 8b, 8c, 8d, 8e and 8f, the body 2 of the phase mask 1 can be fabricated by stacking layers 9, each layer 9 comprising a matrix 3 and pores 4 and having a constant porosity φ, the porosity of one layer 9 being different from the porosity of a directly adjacent layer 9.

With reference to FIG. 8a, a first emulsion 12 is deposited in a mold 19 comprising a polytetrafluoroethylene (PTFE) support and two transparent side walls 20.

With reference to FIG. 8b, the monomers of the emulsion 12 are cross-linked by exposing the emulsion 12 to UV radiation. This exposure is possible thanks to the transparent walls 20. Thermal cross-linking of the emulsion 12 is also possible. The thickness d of the mold (distance between the two walls 20) can be comprised between 0.5 mm and 5 mm when UV cross-linking is used. The thickness may be greater when cross-linking is carried out by heating.

With reference to FIG. 8c, an emulsion 12 with a first phase 13 volume fraction different from that of the emulsion 12 described in FIG. 8a, for example higher, is deposited in the mold 19 on the cross-linked layer 9 described in FIG. 8b.

With reference to FIG. 8d, the monomers of the emulsion 12 described in FIG. 8c are cross-linked to form two juxtaposed layers 9.

The different layers 9 can be dried before each application of a new emulsion.

With reference to FIG. 8e, the different layers 9 can be extracted from the mold 19. The different layers 9 juxtaposed thus form the body 2 of a phase mask 1.

FIG. 8f is a front-view photograph of a phase mask 1, made according to the method described in FIGS. 8a to 8e. The phase 1 mask thus has a porosity gradient, with maximum porosity in the middle of the phase 1 mask and minimum porosity at the lower and upper ends of the phase mask 1. The dotted lines correspond to the boundaries between the different layers 9.

The deposited layers 9 have a height h smaller than the wavelength λ of the incident acoustic wave 6. For example, for a frequency of 100 kHz, the wavelength λ of an incident plane acoustic wave 6 is 15 mm. The layers 9 have a height equal to 8 mm (i.e. about λ/2), which is sufficient for the acoustic index gradient n to be effectively perceived as continuous for the incident plane acoustic wave 6. It is of course possible to reduce the width of the bands, for example to about 1 mm.

With reference to FIGS. 9a, 9b, 9c and 9d, the body 2 may comprise a support 10 with cells 11, each cell 11 containing a matrix 3, at least two of the matrices 3 having different porosities.

With reference to FIGS. 9a and 9b, the support 10 can for example be manufactured by 3D printing. The parameters of 3D printing are chosen so as to manufacture a support 10 in which the cells 11 are delimited by thin thicknesses (typically a hundred micrometers) of polylactic acid (PLA), polyamide (PA) type polymers or any other printable polymer. The emulsions 12 of different volume fractions in the first phase 13 are introduced into the cells 11.

With reference to FIG. 9c, the monomers of all the emulsions 12 can be cross-linked simultaneously, for example by UV exposure through a wall 20. The phase mask 1 may include the support 10. Indeed, the thickness of the support 10 can typically be 0.1 mm, and considered negligible in relation to acoustic wavelengths. Acoustic experiments show that the presence of such a support 10, not filled with material, does not introduce any change in the acoustic field.

With reference to FIG. 9d, the phase mask 1 comprises the body 2, the body 2 comprising a succession of strips or layers 9 and the support 10. The body 2 has a porosity gradient due to the formation of different matrices 3 of different porosities.

### Manipulation of Acoustic Wavefronts

The phase mask 1 may comprise a succession of strips or layers 9, as described above.

With reference to FIGS. 10a and 10b, the phase mask 1 can be used to modify the propagation angle θ between the direction of propagation of an incident plane acoustic wave 6 and that of a transmitted wave 19, i.e. a deflection angle θ with respect to the main plane 7. The incident plane wave 6 of the incident field

$${p}_{inc} = {p}_{0} {e}^{{ik}_{0} z} {e}^{- i ω t}$$

is thus transformed into a transmitted or deflected plane wave 19, of the target field

$${p}_{c} = {p}_{0} {e}^{{ik}_{0} sin θ x} {e}^{{ik}_{0} cos θ z} {e}^{- i ω t} .$$

The spatial distribution of n verifies n(x)=n₀+sin θx/d, n₀=n (x=0) being the index at the center of the phase mask 1. The gradient is preferentially constant, which corresponds to a linear change in the porosity of the body 2 in space. In this case, it is equal to sin θ/d and oriented along the x axis.

With reference to FIGS. 11a and 11b, the phase mask 1 can be used to focus an incident plane acoustic wave 6. The incident plane wave 6, in normal incidence with the phase mask 1, to manipulate the field

$${p}_{inc} = {p}_{0} {e}^{{ik}_{0} z} {e}^{- i ω t}$$

is thus transformed into a convergent cylindrical wave at the focusing point of coordinate z=F with respect to the phase mask 1 whose output face corresponds to the coordinate z=0. Using a far-field approximation, the target field is expressed in the form

$${p}_{c} = \sqrt{2 \text{/} π {k}_{0} r} {e}^{i ( {k}_{0} r - \frac{π}{4} )} {e}^{- i ω t}$$

with r=\sqrt{x²+(z−F)²}. The spatial distribution of the index n in the phase mask 1 is thus given by n(x)=n₀−(\sqrt{x²+F²}−F)/d. With reference to FIG. 11b, the acoustic index n evolves hyperbolically in a part of the body 2.

In all the embodiments, it is possible to make the porosity of the body 2 correspond to a determined index n, as described previously, by using the measured relation between the velocity of the acoustic wave and the porosity of the material through which the acoustic wave passes, illustrated in FIG. 7.

With reference to FIGS. 12a, 12b and 12c, the deflection, and in particular the focusing of an incident plane wave 6 by a phase mask 1 are tested. Phase mask is with a thickness d equal to 2 mm are deposited on the surface of an ultrasonic transducer (supplied by Imasonic) emitting at a central frequency of 150 kHz and having lateral dimensions of 150 mm×40 mm in the plane defined by the x and y axes. The assembly is immersed in a tank filled with water allowing measurements underwater, as performed in underwater acoustics. The ultrasonic transducer is positioned in the upper part of the tank and its active face is oriented towards the bottom so as to generate an incident plane wave propagating from top to bottom along the z axis. The ultrasonic transducer is powered via a function generator (supplied by Agilent) to generate an ultrasonic wave train (30 cycles) in the water centered at 150 kHz. The emitted acoustic pressure is then mapped in the central zone of the near field of this transducer using a needle hydrophone with a diameter of 1 mm (supplied by Precision Acoustics) in the plane XZ (60 mm×100 mm). The step in x and z between each measurement is 2 mm, i.e. 5 times smaller than the wavelength of the ultrasound used. The time signals were recorded using an acquisition card (supplied by Alazartech) with a sampling frequency of 1 MHz over a period of 300 μs for each measurement position.

With reference to FIG. 12a, the transducer is not covered by a phase mask 1. The wavefronts are plane, parallel and horizontal, and are characteristic of a plane wave propagating vertically from the top to the bottom of the vessel as expected along the z axis.

With reference to FIG. 12b, the transducer is covered with a phase mask 1. The phase mask 1 comprises a body with a constant acoustic index gradient (i.e. a linear variation of acoustic index n). The plane, parallel and inclined wavefronts show a deflection of the ultrasonic waves due to the presence of the phase mask 1 on the surface of the ultrasonic transducer. As expected theoretically, the angle θ of deflection of the ultrasonic beam is related to the index gradient and the thickness of the porous material of 2 mm, and is substantially equal to 5°.

With reference to FIG. 12c, the transducer is covered with a phase mask 1. The phase mask 1 comprises a body with a hyperbolic variation in acoustic index n. The mapping of the diffracted acoustic field in FIG. 12c illustrates the existence of a small central zone slightly smaller than the wavelength (i.e. substantially 10 mm) in which the energy of the acoustic beam is concentrated. Furthermore, the converging (and diverging) curved wavefronts respectively visible above and below this focal spot underline the focusing effect of the phase mask 1.

1. An acoustic phase mask (1), the phase mask (1) having a variation in the acoustic index n, characterized in that the phase mask (1) comprises a body (2) comprising:
at least one matrix (3) formed from a deformable solid material having a shear modulus of less than 10 MPa, and
pores (4) formed in the matrix (3), the pores (4) being filled with gas, the deformable solid material extending between the pores (4),
the body (2) having a porosity φ less than or equal to 50%, and a controlled porosity φ gradient resulting in a spatial variation of the acoustic index n in the body (2).

2. The acoustic phase mask (1) as claimed in claim 1, the phase mask (1) being an acoustic lens (5), the porosity gradient being such that the lens is able to focus an incident plane acoustic wave (6) transmitted by the phase mask (1) at at least one point in space.

3. The acoustic phase mask (1) as claimed in claim 1 or 2, the phase mask (1) having two opposite flat sides extending parallel to a main plane (7) and having at least one porosity φ gradient oriented in a direction (8) parallel to the main plane (7).

4. The acoustic phase mask (1) as claimed in claim 3, wherein the porosity is distributed in the body (2) so as to correspond to an index n changing linearly in the direction (8), in at least part of the phase mask (1).

5. The acoustic phase mask (1) as claimed in claim 3 or 4, wherein the porosity is distributed in the body in such a way as to correspond to an index n changing hyperbolically in the direction (8), in at least part of the phase mask (1).

6. The acoustic phase mask (1) as claimed in one of claims 1 to 5, comprising a juxtaposition of layers (9) comprising a matrix (3) and pores (4), each layer (9) having a constant porosity φ, the porosity of one layer (9) being different from the porosity of an immediately adjacent layer (9).

7. The acoustic phase mask (1) as claimed in one of claims 1 to 6, comprising a support (10) having cells (11), each cell (11) containing a matrix (3), at least two matrices (3) having different porosities.

8. The phase mask as claimed in one of claims 3 to 7, wherein the two opposite flat sides are separated by a thickness d, d being comprised between 100 μm and 10 mm.

9. A process for manufacturing an acoustic phase mask (1) as claimed in one of claims 1 to 8, the process comprising the steps of:
forming a plurality of emulsions (12), each emulsion (12) having, on the one hand, a first liquid phase (13) and, on the other hand, a second phase (14) comprising monomers and at least one type of surfactant, so as to form drops of the first liquid phase (13) in the second phase (14), at least two emulsions (12) having different respective fractions in the first phase (13),
cross-linking of the monomers of the emulsions (12) so as to form a deformable solid material (3) defining the matrix or matrices and the pores (4) comprising the first liquid phase (13),
drying to remove the first liquid phase (13) so that the pores (4) are mostly filled with gas.

10. The process for manufacturing an acoustic phase mask (1) as claimed in claim 9, wherein the drying step is a step of supercritical drying of the first liquid phase (13).

11. The process for manufacturing an acoustic phase mask (1) as claimed in claim 10, wherein the first liquid phase (13) comprises, during the step of supercritical drying successively water, a liquid selected from ethanol and acetone, and carbon dioxide.

12. The process for manufacturing an acoustic phase mask (1) as claimed in claim 10, wherein the first liquid phase (13) comprises a liquid compound adapted to spontaneously decompose at room temperature into a gas and a liquid, and wherein, during the drying step, the decomposition of the liquid compound is awaited so as to form a gaseous phase in the pores (4).

13. The process for manufacturing an acoustic phase mask (1) as claimed in claim 12, wherein the compound is hydrogen peroxide.

14. The process for manufacturing an acoustic phase mask (1) as claimed in one of claims 9 to 13, wherein the crosslinking of the monomers is carried out by exposing the emulsions to ultraviolet radiation.
